(19) United States
(12) Patent Application Publication
(10) Pub. No.: US 2004/0225874 A1
(43) Pub. Date: Nov. 11, 2004

(54) Method for reduced BIOS boot time

(76) Inventors: Jeremy Burr, Portland, OR (US); Brian Ostrovsky, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/435,145

(22) Filed: May 9, 2003

(51) Int. Cl. G06F 15/177

(52) U.S. Cl. 713/1

(57) ABSTRACT

An apparatus and method for reducing computer system boot time are described. Boot up data is loaded from a hard disk into a flash memory during a first boot up process. The loaded data is utilized during subsequent boot up processes.

### FIELD

Embodiments of the invention relate to personal computer architecture. Particularly, embodiments of the invention relate to reducing system boot time.

### BACKGROUND

Personal computers take many tens of seconds to boot up through various levels of Basic Input Output System (BIOS), Operating System and application programs. Today, a few tens of seconds can be irritating to a user who desires to have access to information stored electronically as fast as possible.

During a boot up process, a Personal Computer (PC) gradually turns on various hardware and software components in a manner defined within the BIOS instructions. The operating system is then loaded, which enables applications to communicate with various device components that have been installed on the PC. Finally, user specified applications to be executed upon boot up are then installed, upon which the boot up process is complete. In current systems during the boot process, various pieces of executable code are copied from the hard drive into DRAM, where instructions are able to execute faster due to reduced access times. Thus, major time periods consumed during boot up are related to access times of retrieving the executable instructions from hard drive.

A few solutions for the problem of the long boot time of personal computers have been introduced, none of which solve the problem efficiently. One solution is placing the system in a Suspend state rather than turning the system completely off. In this case the system will resume from information held in DRAM, and it will boot faster because DRAM access time is less than the disk drive access time. However, turning the system completely off has advantages that a user may not want to give up, such as, for example, reduced power consumption.

Another existing solution is replacement of a disk drive with all-Flash bulk storage. Although this solution may be successfully applied to Personal Digital Assistants (PDAs) and cellular phones, which do not have large memory requirements as PCS, replacement of the disk drive with Flash memory in PCs is burdensomely expensive due to high cost of Flash memory in comparison to the cost of magnetic media.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1A is a diagram of a process of loading boot up data into flash memory according to one embodiment of the invention;

FIG. 1B is a diagram of a process of utilizing boot up data from the flash memory according to one embodiment of the invention;

FIG. 2 illustrates a system architecture according to one embodiment of the invention;

FIG. 3 illustrates a system architecture according to one embodiment of the invention;

FIG. 4 illustrates a system architecture according to one embodiment of the invention;

FIG. 5 illustrates a system architecture according to one embodiment of the invention;

FIG. 6 illustrates a system architecture according to one embodiment of the invention;

FIG. 7 illustrates a system architecture according to one embodiment of the invention; and

FIG. 8 illustrates a system architecture according to one embodiment of the invention.

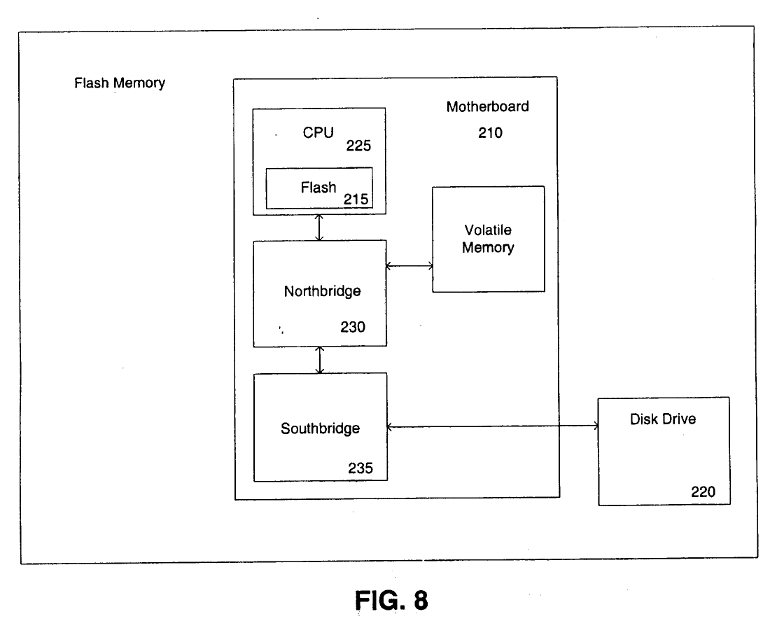

### DETAILED DESCRIPTION

Although the invention is described below by way of various embodiments that include specific structures and methods, embodiments that include alternative structures and methods may be employed without departing from the principles of the invention described herein.

In general, embodiments described below feature a method for reducing system boot time. One embodiment features a reduction of system boot time after the first clean boot by utilizing boot flash memory in the system.

Introduction to Related Technology

Some introduction to related technology may be helpful in understanding embodiments of the invention.

One embodiment of the invention utilizes Dynamic Random Access memory (DRAM). DRAM is a type of computer memory that utilizes one transistor and one capacitor to represent a bit of data. The capacitors are usually energized hundreds of times per second to maintain the charge. Unlike firmware chips, such as ROM, DRAM looses its content when the power is turned off.

Another embodiment of the invention utilizes flash memory. Flash memory is a memory chip, content of which can be stored without any power source. Unlike DRAM memory chips, in which a single byte can be written, flash memory is erased and written in fixed blocks, typically ranging from 512 bytes up to 256 KB.

One embodiment of the invention utilizes power modes S1, S2, S3, S4 and S5. S1 is a full power mode state, in which the power is fully supplied to components of a computer system. States S1, S2 and S3 are levels of “Suspend” power mode states, in which a processor is stopped and the system state and context is stored in memory. State S4 is a “Hibernate” power mode state, in which the entire system is stopped and all of the system states and contexts are stored on disk. State S5 is a complete power off mode state.

One embodiment of the invention utilizes Northbridge and Southbridge chipsets. The Northbridge chipset is a controller for the front side bus that interfaces between the Central Processing Unit (CPU) and all high speed components such as memory, the Accelerated Graphics Port (AGP) bus and the Peripheral Component Interconnect (PCI) bus. The Southbridge chipset, which stems from the PCI bus, is the controller for Integrated Drive Electronics (IDE) drives and lower-speed ports, such as Universal Serial Bus (USB), serial port, audio port, etc.

One embodiment of the invention utilizes a motherboard. Motherboard, also called the “system board,” is the main printed circuit board in an electronic device, which contains sockets that accept additional boards. In a personal computer, the motherboard contains the bus, CPU and coprocessor sockets, memory sockets, keyboard controller and supporting chips.

One embodiment of the invention utilizes a concept of “drive mapping”. Drive mapping is an assignment of a letter to a disk or tape drive. In a PC, the basic drive mappings are A for a floppy disk, B for a second floppy disk, C for the primary hard drive. When new peripherals are added to the system, new drive mappings are assigned by the operating system to those peripherals based on the next available letter. Drive mapping allows data to be accessed via memory addressing handled locally in the disk drive and being transparent to the system memory architecture. Another embodiment of the invention utilizes a concept of “direct mapping into memory architecture”, which allows data to be accessed through direct memory addressing.

One embodiment of the invention utilizes Basic Input Output System (BIOS). BIOS is a set of routines in a Personal Computer (PC) that provides an interface between hardware and an Operating System (OS). On startup, BIOS tests a computer system and prepares the system for operation by querying BIOS's small Complimentary Metal Oxide Semiconductor (CMOS) memory bank for drive and other configuration settings. It searches for other BIOS's on the plug-in boards and sets up pointers, i.e. interrupt vectors, in memory to access those routines. It then loads the operating system and passes control to it.

It will be appreciated that the terms “boot” and “boot up” are used interchangeably and, as used herein mean to cause a computer system to start executing instructions. When a user turns on a computer, the operating system has been set up to boot, i.e. load into Random Access Memory (RAM) automatically in a sequence. First, as soon as the computer is turned on, BIOS located in Read Only Memory (ROM) takes charge of the system and performs a power-on self test (POST) to make sure all the computer's components are operational. After a successful POST operation, BIOS locates boot programs to load the operating system onto the hard disk. Usually, the information is located on the system disk or on a diskette inserted into one of the drives of the computer. Upon identification of the drive where boot files are located, BIOS locates the first sector information, known as boot record or Master Boot Record. It then loads the boot record into a specific place in RAM, upon which the boot record controls the computer. The boot record loads the initial system file, for example, for DOS systems, IO.SYS, into RAM from the diskette or hard disk. The initial file then loads the rest of the operating system into RAM. The initial file loads a system file that is configured to operate with BIOS. One of the first operating system files that is loaded is a system configuration file. Information in the configuration file provides the loading program with identification of specific operating system files to be loaded. Another file that is loaded specifies applications and/or commands the user identified to be included and performed as part of the boot process. After the operating system files have been loaded, the operating system is given control of the computer, which performs requested initial commands waiting for the first interactive user input. This boot process may take several tens of seconds when the computer is turned on from a complete shut down position, i.e. Clean Boot during which the system does not restore previous sessions.

Methodology

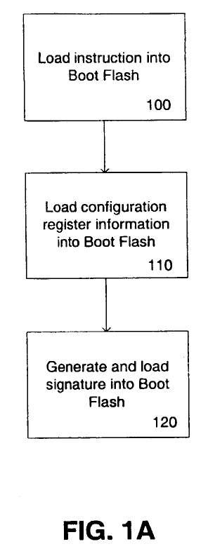

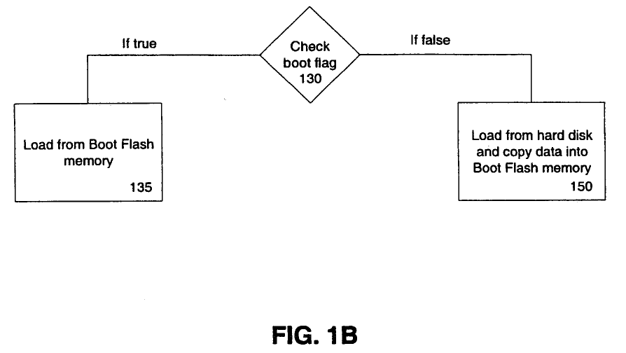

With these concepts in mind embodiments of the invention can be further described with reference to FIG. 1A. At 100 BIOS instructions that are copied into DRAM during a first clean boot up process are copied into Boot Flash memory to allow all subsequent booting processes retrieve information from the Boot Flash memory, rather than the hard drive, which would reduce data access times.

Thus, if a PC requires a cold reboot due to internal data corruption or due to the PC passing through cold reboot after it was turned off, these successive reboot processes will utilize information stored in the Boot Flash rather than information stored on the hard drive of the PC, which as stated earlier reduces data access times.

In one embodiment of the invention at 110 of FIG. 1A, configuration register information defined by the operating system is loaded into the Boot Flash. This information may be updated periodically to ensure that the boot up process is executed without any data corruption.

In one embodiment of the invention at 120 of FIG. 1A, a signature is generated and stored in the Boot Flash to ensure that the correct boot up sequence is executed. In one embodiment the signature is a checksum generated according to methods well known in the art and thus, no further details need to be provided. The signature may be checked at the beginning of every boot up process executed from the Boot Flash. If the signature check is not successfully completed, indicating possible corruption of the data, then the boot process may retrieve boot up instructions from the hard drive and replace data of the Boot Flash with the data retrieved from the hard drive, upon which new signature is generated and stored in the Boot Flash.

In one embodiment if changes were introduced into configuration registry, then during the subsequent cold boot configuration registry data is reloaded into the boot flash. Change to the configuration data, i.e. addition of a hardware device or software program to the system, is usually followed by a system reboot cycle to introduce changes into the system.

In one embodiment user's applications and/or user's data are stored in the Boot Flash memory space that remained free after loading the BIOS instructions and operating system components. In another embodiment the user's applications and user's data are loaded from the hard drive upon loading of the operating system.

During a cold boot up of the system, BIOS checks a boot flag at 130 of FIG. 1B, which indicates whether the Boot Flash memory contains necessary boot process information and, thus BIOS should retrieve all the necessary files from the Boot Flash memory. For example, if configuration data was changed due to an addition of a new hardware or software component to the system, the boot flag will indicate presence of new information in the configuration data. If the boot flag is set to true, indicating presence of new configuration data, BIOS retrieves all the necessary files and configuration data from the hard disk and reloads all data into the Boot Flash memory at 135. If the boot flag is set to false, then BIOS performs the signature check of data located in the Boot Flash memory, as described above. If the signature check is successful the BIOS utilizes data in the Boot Flash memory to load the system at 150.

Architecture

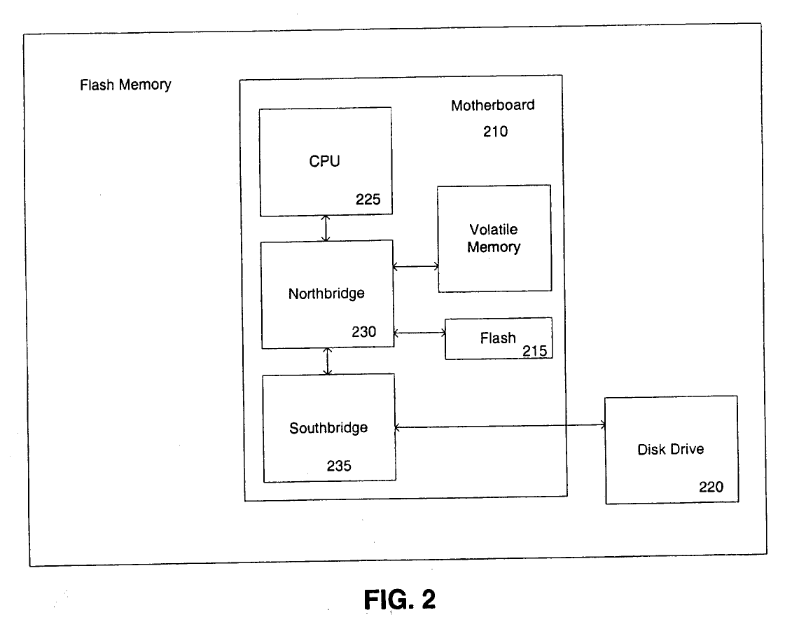

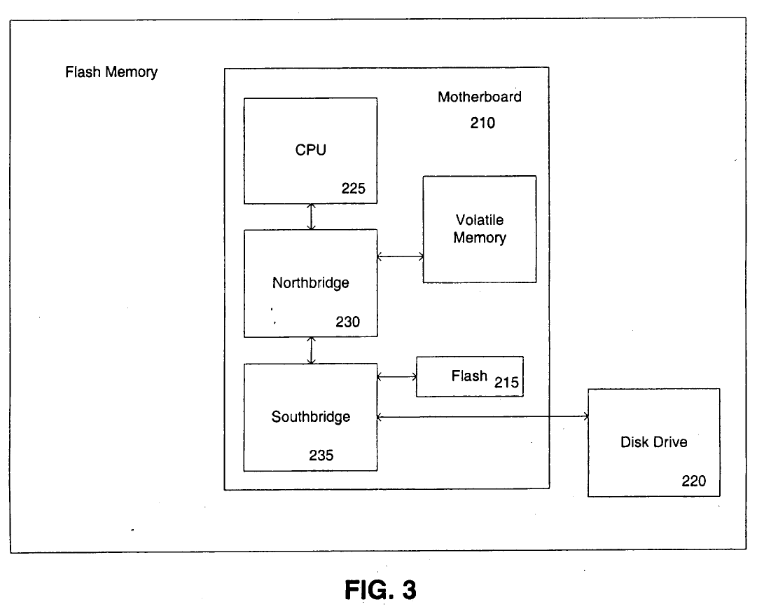

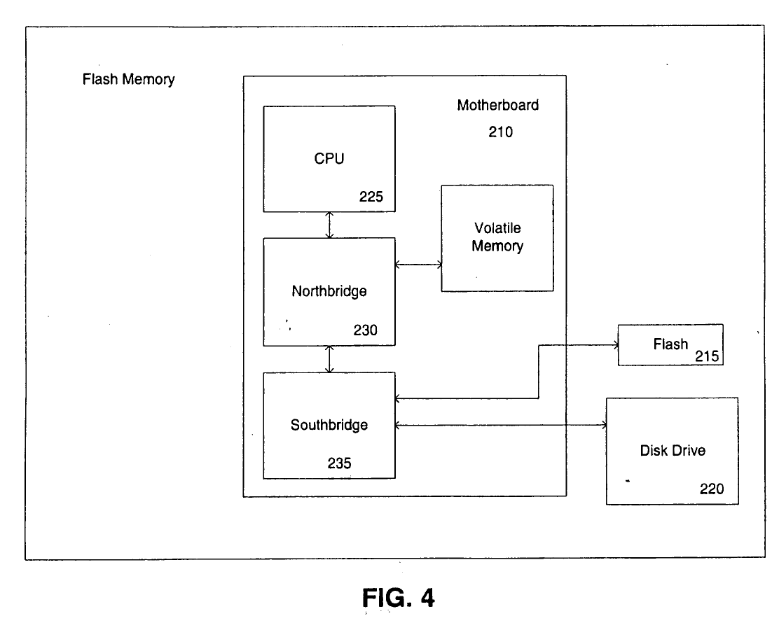

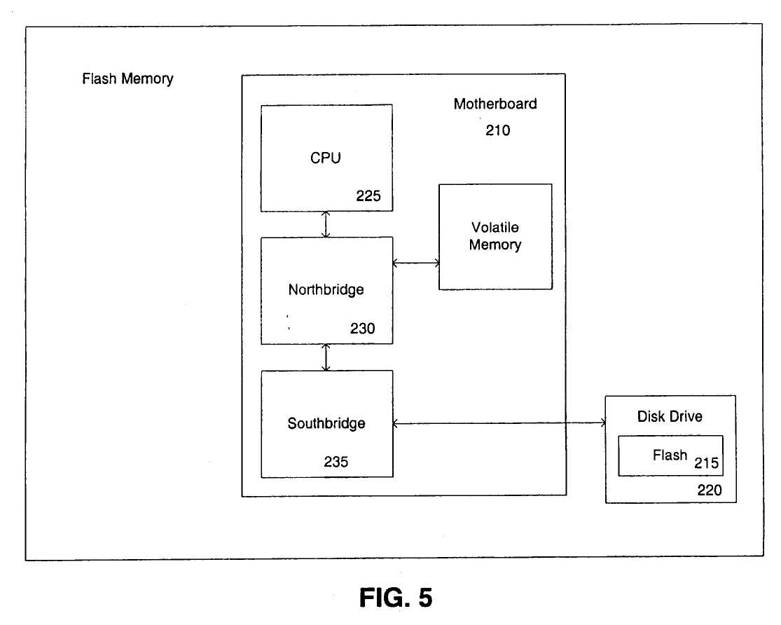

According to embodiments of the invention, the Boot Flash memory may be located in several locations within the Flash Memory of the PC. FIGS. 2 illustrates the Boot Flash Memory 215 located on the motherboard 210, directly mapped into the memory architecture according to one embodiment of the invention. FIG. 3 illustrates the Boot Flash Memory 215 located on the motherboard 210 and mapped as a drive according to one embodiment of the invention. FIG. 4 illustrates the Boot Flash Memory 215 attached to the motherboard via an Integrated Drive Electronics (IDE) connector, being mapped as a drive. FIG. 5 illustrates the Boot Flash memory 215 contained within the Disk Drive 220 itself with the mapping of the Boot Flash memory 215 being transparent to the system, i.e. the copying of data and reloading of data is being performed within the Disk Drive 220 itself without being exposed to the external system allowing the disk drive retain its previous drive mapping.

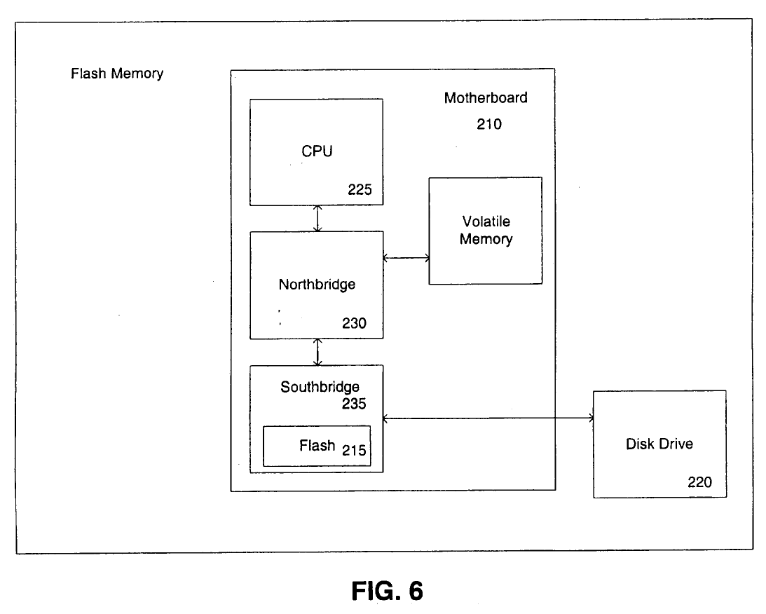

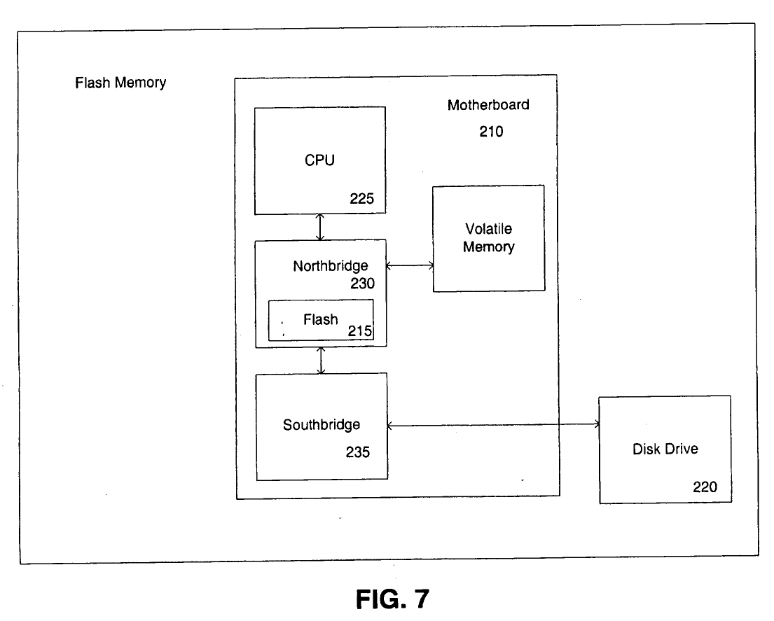

In one embodiment of the invention it is possible to place the Boot Flash memory 215 closer to the CPU 225. FIG. 6 illustrates the Boot Flash memory 215 contained within the Northbridge chipset 230 directly mapped into the memory architecture. FIG. 7 illustrates the Boot Flash memory 235 contained within the Southbridge chipset 235 also directly mapped into the memory architecture. The Boot Flash memory may also be located within the processor 225 itself and be mapped into the memory architecture as illustrated in FIG. 7.

It will be recognized that many of the features and techniques described above may be implemented in software. Likewise, hardwired circuitry may be used in place of software, or in combination with software, to implement the features described herein. Thus, the present invention is not limited to any specific combination of hardware circuitry and software, nor to any particular source of software. Moreover, components of the invention may reside on a processing system including a processor and a storage medium, such as a personal computer server-class computer, workstation, etc. Processing systems such as this are well known in the art and do not require any further explanation. A machine-accessible medium can store instructions and/or data to implement the process described above. The machine-accessible medium includes any mechanism that provides, i.e. stores and/or transmits, information in a form accessible by a machine, e.g., a computer, network device, personal digital assistant, manufacturing tool, any device with a set of one or more processors, etc. For example, a machine-accessible medium includes recordable and/or nonrecordable media, e.g. read only memory (ROM), random access memory (RAM), magnetic disk storage media, optical storage media, flash memory devices, etc., as well as electrical, optical, acoustical or other form of propagated signals, e.g. carrier waves, infrared signals, digital signals, etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
loading boot up data from a hard disk into a flash memory during a first boot up process; and
utilizing the data from the flash memory during subsequent boot up processes.

2. The method of claim 1 wherein the first boot up process is a first cold boot up process.

3. The method of claim 1 further comprising determining accuracy of the data prior to utilizing the data from the flash memory during subsequent boot up processes.

4. The method of claim 3 wherein the determining the accuracy of the data comprises performing a signature check.

5. The method of claim 1 wherein the boot up data includes operating system data.

6. The method of claim 1 wherein the boot up data includes configuration data.

7. The method of claim 1 wherein the boot up data includes user-specified programs data.

8. A method comprising:
retrieving boot up data from a hard disk during a first boot up process; and
copying the data into a flash memory to use in subsequent boot up processes.

9. The method of claim 8 further comprising loading configuration register data into the flash memory.

10. The method of claim 8 further comprising generating a signature and loading the signature into the flash memory.

11. The method of claim 8 wherein the boot up data includes operating system data.

12. The method of claim 8 wherein the boot up data includes user specified programs data.

13. A method comprising:
retrieving boot up data from a flash memory, the data placed into the flash memory during a previous boot up process; and
loading an operating system based on the data.

14. The method of claim 13 further comprising loading user-specified programs based on the data.

15. The method of claim 13 comprising determining accuracy of the data prior to utilizing the data to load the operating system.

16. The method of claim 15 comprising discarding data retrieved from the flash memory and retrieving boot up data from a hard disk if the data in the flash memory is not accurate.

17. The method of claim 16 further comprising reloading boot up data into the flash memory.

18. An apparatus comprising:
a machine-accessible medium including data that, when accessed by a machine, cause the machine to perform operations comprising:
loading boot up data into a flash memory during a first boot up process;
utilizing the data from the flash memory during subsequent boot up processes.

19. The apparatus of claim 18 wherein the operations further comprise determining accuracy of the data prior to utilizing the data from the flash memory during subsequent boot up processes.

20. The apparatus of claim 19 wherein the determining accuracy of the data comprises performing a signature check.

21. The apparatus of claim 18 wherein the boot up data includes operating system data.

22. The apparatus of claim 18 wherein the boot up data includes user specified programs data.

23. A system comprising:
a processor;
a hard disk to store data; and
a flash memory to store boot up data loaded from the hard disk to boot up the system.

24. The system of claim 23 further comprising a Basic Input Output System (BIOS) to boot up the system utilizing the data stored in the flash memory.

25. The system of claim 23 wherein the flash memory is located on a motherboard and is mapped into a memory architecture.

26. The system of claim 23 wherein the flash memory is located on a motherboard and mapped as a drive.

27. The system of claim 23 wherein the flash memory is attached to a motherboard via an Integrated Drive Electronics (IDE) connector and is mapped as a drive.

28. The system of claim 23 wherein the flash memory is located in the hard disk and mapping of the flash memory is transparent.

29. The system of claim 23 wherein the flash memory is located within a chipset and is directly mapped into a memory architecture.

30. The system of claim 23 wherein the flash memory is located within the processor and is mapped into a memory architecture.
